(19) United States
(12) Patent Application Publication
(10) Pub. No.: US 2013/0257815 A1
(43) Pub. Date: Oct. 3, 2013

(54) INTERACTIVE INPUT SYSTEM AND METHOD

(71) Applicant: SMART TECHNOLOGIES ULC, Calgary (CA)

(72) Inventors: ROBBIE RATTRAY, Calgary (CA); DAVID GREGORY POPOVICH, Calgary (CA)

(73) Assignee: SMART TECHNOLOGIES ULC, Calgary (CA)

(21) Appl. No.: 13/834,602

(22) Filed: Mar. 15, 2013

Related U.S. Application Data
(60) Provisional application No. 61/618,691, filed on Mar. 31, 2012.

(51) Int. Cl. G06F 3/042

(52) U.S. Cl. CPC G06F 3/0421
USPC 345/175

(57) ABSTRACT

An interactive input system comprises a display panel defining an interactive surface, the display panel comprising a light sensitive layer configured to sense illumination impinging thereon; and processing structure in communication with the display panel, said processing structure processing output of the light sensitive layer to detect at least one pointer in proximity with the interactive surface.

### CROSS-REFERENCE TO RELATED APPLICATION

This application claims the benefit of U.S. Provisional Application No. 61/618,691 to Rattray et al. filed on Mar. 31, 2012, the entire disclosure of which is incorporated herein by reference.

### FIELD OF THE INVENTION

The present invention relates to an interactive input system and method.

### BACKGROUND OF THE INVENTION

Interactive input systems that allow users to inject input (e.g., digital ink, mouse events etc.) into an application program using an active pointer (e.g., a pointer that emits light, sound, or other signal), a passive pointer (e.g., a finger, cylinder or other suitable object) or other suitable input devices such as for example, a mouse, or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies of ULC of Calgary, Alberta, Canada, assignee of the subject application, the entire disclosures of which are incorporated by reference; touch systems comprising touch panels employing electromagnetic, capacitive, acoustic or other technologies to register pointer input; tablet and laptop personal computers (PCs); smartphones, personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

Above-incorporated U.S. Pat. No. 5,448,263 to Martin discloses an interactive display system comprising a touch sensitive display surface for sensing pressure applied thereto, and in response generating control signals indicating locations of the applied pressure. A personal computer coupled to the touch surface receives the control signals and in response generates graphic images. A liquid crystal (LCD) panel in combination with an overhead projector receives and projects the graphic images onto the touch sensitive display surface at the indicated locations.

Although various interactive input systems have been considered, improvements in pointer detection in interactive input systems is generally desired. It is therefore an object to provide a novel interactive input system and method.

### SUMMARY OF THE INVENTION

Accordingly, in one aspect there is provided an interactive input system comprising a display panel defining an interactive surface, the display panel comprising a light sensitive layer configured to sense illumination impinging thereon; and processing structure in communication with the display panel, said processing structure processing output of the light sensitive layer to detect at least one pointer in proximity with the interactive surface.

In one embodiment, the display panel further comprises a layer configured to scatter illumination emitted by a light source. The layer scatters illumination such that the scattered illumination both impinges on the light sensitive layer and exits the display panel for reflection back into the display panel and onto the light sensitive layer by at least one pointer in proximity with the interactive surface. The scattered illumination impinging on the light sensitive layer is of a generally uniform intensity over the surface area thereof. The illumination may be infrared illumination.

In one embodiment, the light sensitive layer comprises an array of light sensitive elements, each light sensitive element generating a measurable output that is a function of illumination impinging thereon. The light sensitive elements may comprise an array of photovoltaic cells or an array of photodiodes.

According to another aspect, there is provided a method comprising detecting illumination reflected into a display panel by a pointer brought into proximity with the display panel; and detecting the existence and status of the pointer based on the detected illumination.

In one embodiment, the detecting is performed by an array of light sensitive elements within the display panel and wherein during the second detecting, outputs of the light sensitive elements are compared to a first threshold value and a second threshold value to determine hover contact status of the pointer.

According to another aspect, there is provided a display panel comprising a light sensitive layer; and a layer configured to scatter received illumination in one direction so that the scattered illumination impinges generally evenly on said light sensitive layer and in an opposite direction so that said scattered illumination exits said display panel, scattered illumination exiting said display panel that is reflected by a pointer in proximity thereto and travels back into said display panel impinging on said light sensitive layer.

### BRIEF DESCRIPTION OF THE DRAWINGS

Embodiments will now be described more fully with reference to the accompanying drawings in which:

FIG. 1 is a perspective view of an interactive input system;

FIG. 2 is an exploded view of a display panel forming part of the interactive input system of FIG. 1;

FIG. 3 is a perspective view of an organic photovoltaic (OPV) layer forming part of the display panel of FIG. 2;

FIG. 4 is a schematic sectional view of a photovoltaic cell forming part of the OPV layer of FIG. 3;

FIG. 5 is a diagram of the OPV layer and an OPV layer controller connected thereto;

FIG. 6 is a schematic sectional view of the display panel of FIG. 2, during use;

FIG. 7 is a flowchart showing steps of a pointer location method used by the interactive input system of FIG. 1;

FIG. 8 is an exploded view of another embodiment of a display panel;

FIG. 9 is an exploded view of still another embodiment of a display panel;

FIG. 10 is an exploded view of still another embodiment of a display panel;

FIG. 11 is a schematic sectional view of still another embodiment of a display panel, during use;

FIG. 12 is a schematic sectional view of still another embodiment of a display panel, during use;

FIG. 13 is a circuit diagram of an analog block forming part of another embodiment of an OPV layer controller; and

FIG. 14 is a perspective view of another embodiment of an interactive input system.

### DETAILED DESCRIPTION OF THE EMBODIMENTS

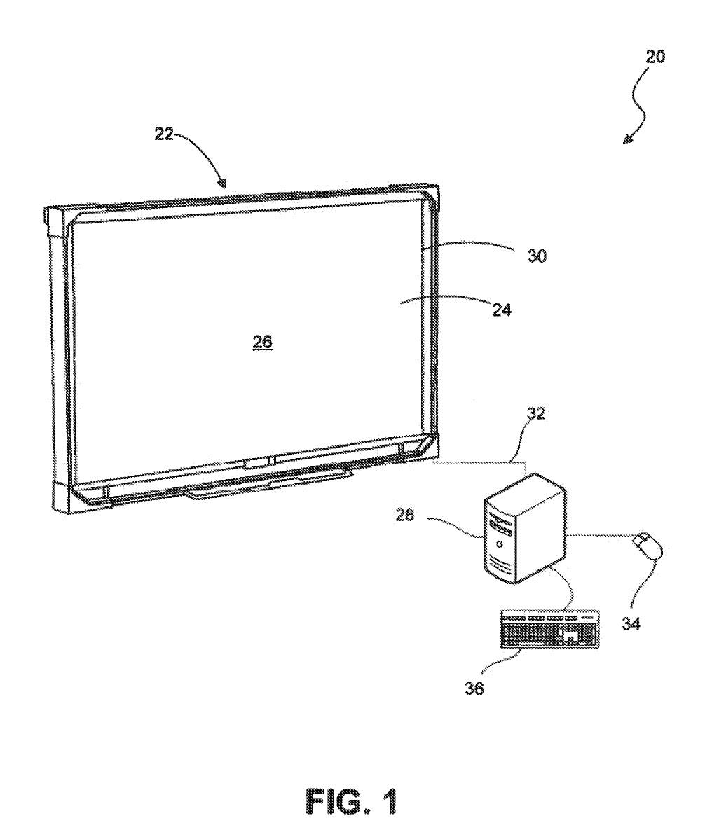

Turning now to FIG. 1, an interactive input system that allows a user to inject input such as digital ink, mouse events etc. into an executing application program is shown and is generally identified by reference numeral 20. In this embodiment, interactive input system 20 comprises an interactive board 22 mounted on a vertical support surface such as for example, a wall surface or the like or otherwise supported or suspended in an upright orientation. Interactive board 22 comprises a display panel 24 that displays an image, such as for example a computer desktop. The display panel 24 in this embodiment is a liquid crystal display (LCD) panel having a generally planar, rectangular display surface that defines an interactive surface 26.

The interactive board 22 is able to detect one or more pointers brought into proximity with the interactive surface 26 and communicates with a general purpose computing device 28 executing one or more application programs via a universal serial bus (USB) cable 32 or other suitable wired or wireless communication link. General purpose computing device 28 processes the output of the interactive board 22 and adjusts image data that is output to the display panel of the interactive board 22, if required, so that the image presented on the interactive surface 26 reflects pointer activity. In this manner, the interactive board 22 and general purpose computing device 28 allow pointer activity proximate to the interactive surface 26 to be recorded as writing or drawing or used to control execution of one or more application programs executed by the general purpose computing device 28.

The general purpose computing device 28 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The computing device 28 may also comprise networking capability using Ethernet, WiFi, and/or other network format, for connection to access shared or remote drives, one or more networked computers, or other networked devices. The general purpose computing device 28 is also connected to the world wide web via the Internet.

The interactive input system 20 is able to detect passive pointers such as for example, a user's finger, a cylinder or other suitable object as well as passive and active pen tools that are brought into proximity with the interactive surface 26. The user may also enter input or give commands to the general purpose computing device 28 through a mouse 34 or a keyboard 36. Other input techniques such as voice or gesture-based commands may also be used by the user to interact with the interactive input system 20.

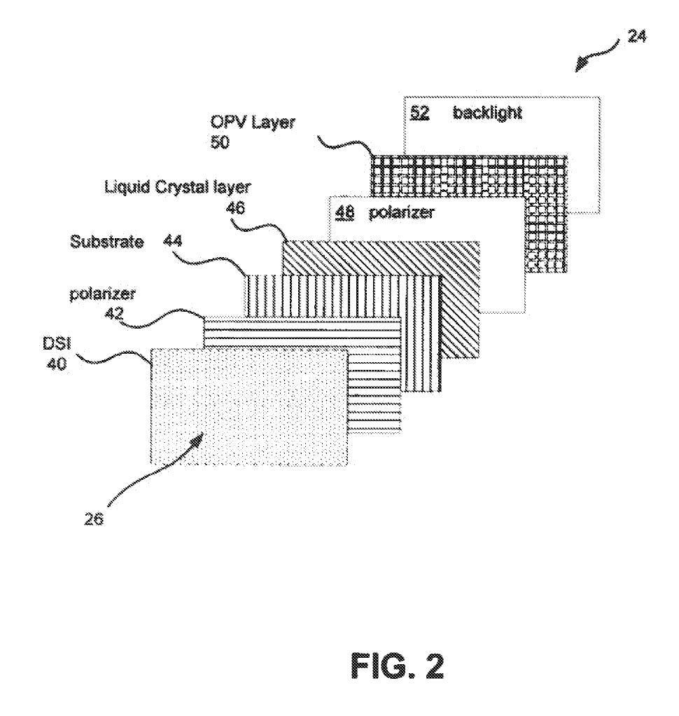

The display panel 24 is better seen in FIG. 2. Display panel 24 comprises a plurality of transparent and semi-transparent layers that are arranged in a stacked sequence. In this embodiment, the display panel 24 comprises, in order from top-to-bottom or front-to-back, a diffused surface illumination (DSI) layer 40, a first polarizer layer 42, a substrate layer 44, a liquid crystal layer 46, a second polarizer layer 48, a light sensitive layer in the form of an organic photovoltaic (OPV) layer 50 and a backlight layer 52. The backlight layer 52 comprises an array of light emitting diodes (LEDs) (not shown) and a diffuser layer (not shown) adjacent the LEDs for diffusing light emitted therefrom and providing backlight illumination to the layers above or in front of it.

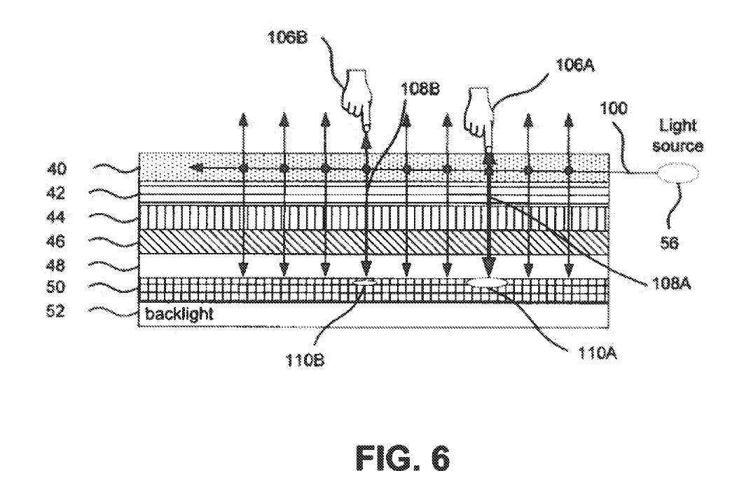

In this embodiment, the interactive board 22 also comprises a light source 56 (see FIG. 6) positioned adjacent the periphery of the DSI layer 40, and which is configured to emit illumination into the plane of the DSI layer 40. In this embodiment, the illumination emitted by the light source 56 is infrared (IR) illumination. The DSI layer 40 is configured to scatter illumination emitted by the light source 56. In particular, the DSI layer 40 scatters illumination emitted by the light source 56 such that the OPV layer 50 receives a substantially uniform amount of scattered incident illumination over its surface area and such that illumination exits the display panel 24 and travels outwardly from the interactive surface 26.

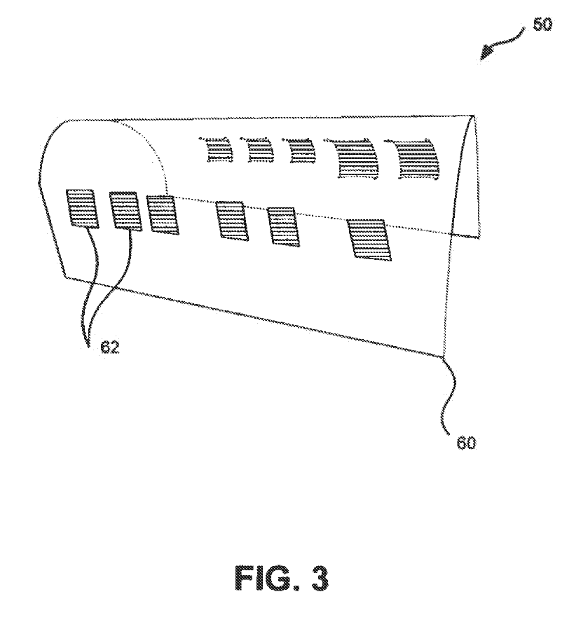

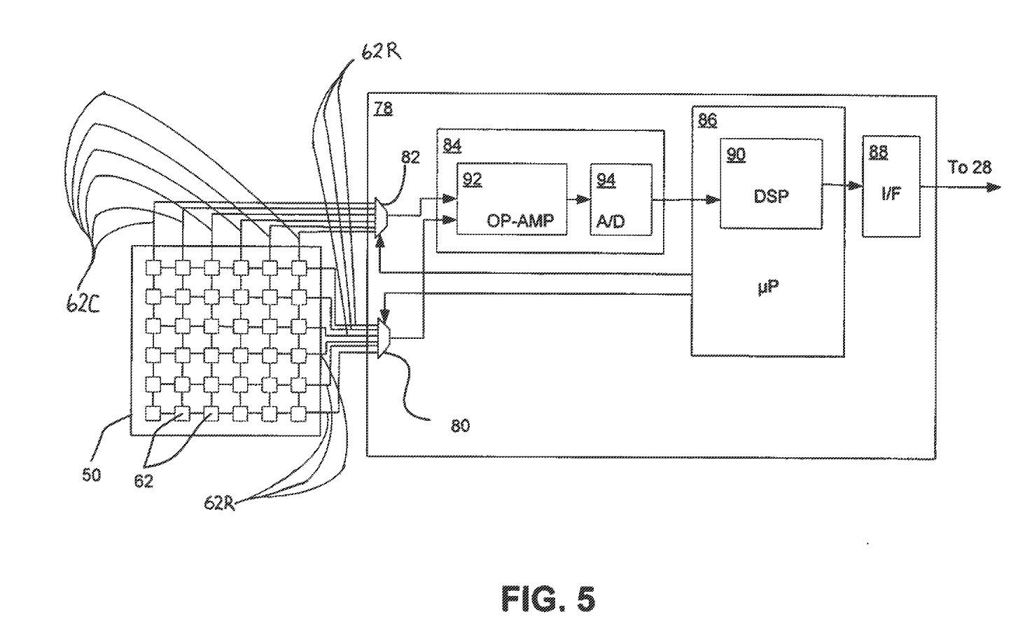

The OPV layer 50 is better seen in FIGS. 3 and 5. OPV layer 50 is flexible and comprises a transparent substrate 60 on which an array of photovoltaic cells 62 is disposed. The photovoltaic cells 62 are formed on the substrate 60 using known organic semiconductor thin film deposition and patterning processes. Each of the photovoltaic cells 62 is configured to generate an electrical current, namely a photocurrent, upon exposure to and absorption of light. In this embodiment, the photovoltaic cells 62 are configured to absorb light having wavelengths that include the wavelengths of the infrared illumination emitted by the light source 56, and are configured to be transparent or semi-transparent in the visible range. The photovoltaic cells 62 of each row of the array are interconnected by row conductors 62R and the photovoltaic cells 62 of each column of the array are interconnected by column conductors 62C. It will be understood that FIG. 5 is a schematic illustration, and that the number and arrangement of the photovoltaic cells 62 within the OPV layer 50 may vary from that illustrated.

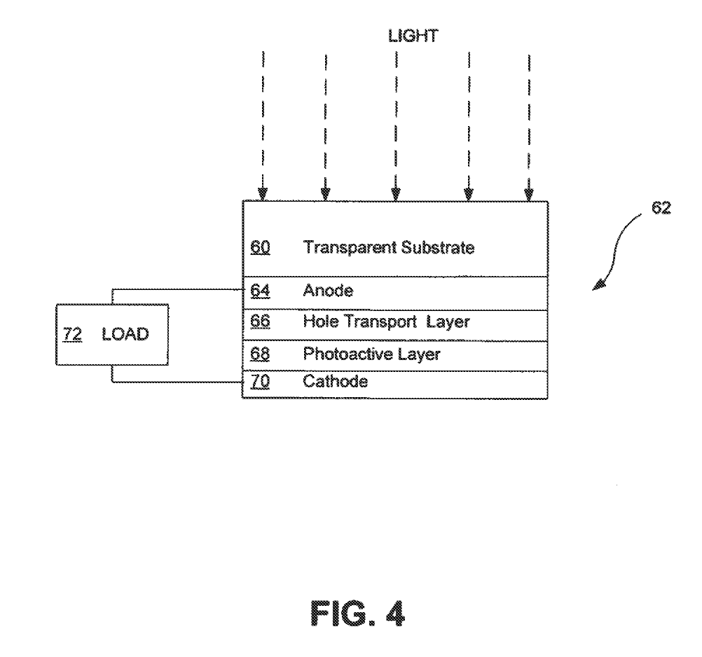

The structure of one of the photovoltaic cells 62 is shown in FIG. 4. Each photovoltaic cell 62 comprises an anode layer 64, a hole transport layer 66, a photoactive layer 68 and a cathode layer 70. When the photovoltaic cell 62 is exposed to light, photons are absorbed within the photoactive layer 68, giving rise to charge carrier separation therein and yielding electrons and holes. The holes travel through the hole transport layer 66 to the anode layer 64. The electrons travel to the cathode layer 70 and power load 72 connected across the anode layer 64 and cathode layer 70. After powering the load 72, the electrons travel to the anode layer 64, where they recombine with the holes.

As will be understood, the travel of the electrons from the photoactive layer 68 to the anode layer 64 corresponds to the photocurrent. For a typical load 72, the current drawn from the photovoltaic cell 62 depends on the amount of light incident thereupon, and in turn the amount of light absorbed by the photovoltaic cell 62. The voltage measured across the load 72 is therefore a function of the amount of light incident on the photovoltaic cell 62. Accordingly, and as will be understood, the photovoltaic cell 62 can effectively serve as a light sensor.

The OPV layer 50 is in communication with an OPV layer controller 78 also shown in FIG. 5. As can be seen, the OPV layer controller 78 comprises two multiplexers 80 and 82, an analog block 84, a microprocessor 86 and an interface block (I/F) 88. Multiplexer 80 receives each row conductor 62R as input and multiplexer 82 receives each column conductor 62C as input. In this embodiment, the analog block 84 comprises an operational amplifier (OP-AMP) 92 that receives the outputs of the multiplexers 80 and 82 and an analog-to-digital (A/D) converter 94 that converts the analog output of the OP-AMP 92 to digital form. In this embodiment, the analog-to-digital converter 94 is a simple threshold comparator that samples the analog output of the OP-AMP 92 and outputs a binary value for each sample. However, in other embodiments, the analog-to-digital converter 94 may alternatively be any suitable N-bit A/D converter and such A/D converters are commercially available.

In this embodiment, the microprocessor 86 comprises a digital signal processor 90 embodying a clock source that receives the output of A/D converter 94. The microprocessor 86 is also in communication with the multiplexers 80 and 82, and is configured to poll each individual row-column pair of conductors 62R, 62C to measure the output of each photovoltaic cell 62 in the OPV layer 50.

The interface block 88 is in communication with the general purpose computing device 28, and provides an interface between the DSP 90 and the general purpose computing device 28 for communication of pointer position data.

FIG. 6 shows the display panel 24 during use. As the operation of the display panel 24 during display of images is well known to those of skill in the art, this operation of the display panel 24 will not be described herein. The operation of the display panel 24 to detect pointer interaction with the interactive surface 26 will however, now be described. AS described above, the DSI layer 40 scatters illumination 100 emitted by light source 56, such that scattered illumination both exits the display panel 24 and travels outwardly from the interactive surface 26, and travels inwardly toward the OPV layer 50. In this manner, the OPV layer 50 receives a substantially uniform amount of scattered incident illumination over its entire surface area. The incident illumination that impinges on the photovoltaic cells 62 of the array results in charges being stored by the photovoltaic cells. As the incident illumination is generally uniform across the surface area of the OPV layer 50, the changes stored by the photovoltaic cells 62 are substantially equal.

When a pointer is brought into proximity with the interactive surface 26, scattered illumination exiting the display panel 24 and traveling outwardly from the interactive surface 26 is reflected by the pointer back toward the display panel 24. This reflected illumination travels into the display panel 24 and impinges on the OPV layer 50 thereby creating a region within the OPV layer having an increased amount of incident illumination. This increased amount of incident illumination will vary depending on the spacing between the pointer and the interactive surface 26.

For example, in FIG. 6 pointer 106A brought into proximity with the interactive surface 26 reflects scattered illumination exiting the display panel 24 and traveling outwardly from the interactive surface 26 back toward the display panel 24 as ray 108A. As a result, ray 108A travels back into the display panel 24 and impinges on the OPV layer 50 thereby creating a region 110A of the OPV layer 50 having an increased amount of incident illumination. Pointer 106B brought into proximity with the interactive surface 26 also reflects illumination exiting the display panel 24 and traveling outwardly from the interactive surface 26 back toward the display panel 24 as ray 108B. Ray 108B also travels back into the display panel 24 and impinges on the OPV layer 50 thereby creating a region 110B of the OPV layer 50 having an increased amount of incident illumination. In this embodiment, pointers 106A and 106B are identical in shape. However, because pointer 106A is closer to the interactive surface 26 than pointer 106B, pointer 106A reflects a greater amount of scattered illumination back toward the display panel 24 than pointer 106B. As a result, region 110A has a greater amount of incident illumination than region 110B. The relative differences in the amount of incident illumination between region 110A, region 110B, and the remainder of the OPV layer 50, result in different charges accumulated by photovoltaic cells 62 on the OPV layer, which are measureable by the OPV layer controller 78 as will be described.

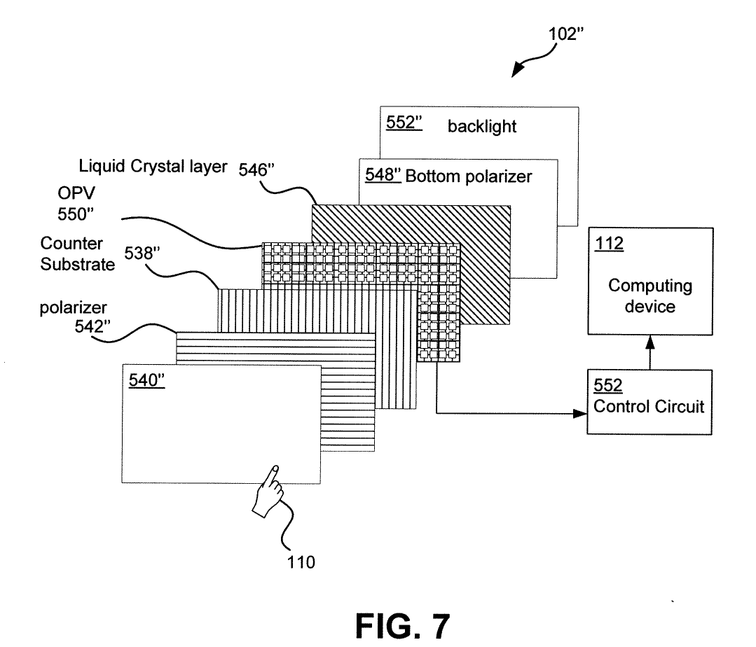

The process by which the locations of pointers brought into proximity with the interactive surface are calculated is shown in FIG. 7 and generally indicated by reference numeral 200. During the process, the OPV layer controller 78 measures the voltage output of each photovoltaic cell 62 one at a time (step 204). To measure the voltage output of a given photovoltaic cell 62, the microprocessor 86 signals the multiplexers 80 and 82 causing them to connect the row and column conductors 62R, 62C that are connected to the desired photovoltaic cell 62 to the OP-AMP 92 thereby applying the resulting voltage difference appearing on the selected row and column conductors 62R, 62C to the OP-AMP 92. As mentioned above, the voltage output of the photovoltaic cell 62 is a function of the amount of light incident thereon. Accordingly, a photovoltaic cell 62 having a large amount of light incident thereon will yield a large voltage difference, while a photovoltaic cell 62 having a small amount of light incident thereon will yield a small voltage difference. The voltage difference received by the OP-AMP 92 is the amplified and converted to a digital value by A/D converter 94 before being conveyed to the microprocessor 86.

After each photovoltaic cell 62 has been polled, the microprocessor 86 determines the position of each pointer in proximity with the interactive surface 26 by comparing the measured voltage output of each photovoltaic cell 62 to at least one voltage threshold value (step 206). In this embodiment, the microprocessor 86 initially compares the measured voltage output, V₀, of each photovoltaic cell 62 to a first voltage threshold value, V₁, and then possibly to a second voltage threshold value, V₂, to determine if a pointer has been brought close to or into contact with the interactive surface 26. If the voltage output V₀ of a photovoltaic cell 62 is less than first voltage threshold value V₁, then the microprocessor 86 determines that no pointer has been brought into proximity with the interactive surface 26 adjacent that photovoltaic cell 62. If the voltage output V₀ of a photovoltaic cell 62 is greater than first voltage threshold value V₁ but less than second voltage threshold value V₂, then the microprocessor 86 determines that a pointer has been brought into proximity with the interactive surface, but not into contact with the interactive surface 26, and is therefore hovering near the interactive surface 26 adjacent that photovoltaic cell 62. If the voltage output V₀ of a photovoltaic cell 62 is greater than the second voltage threshold value V₂, then the microprocessor 86 determines that a pointer has been brought into contact with the interactive surface 26 adjacent that photovoltaic cell 62.

After the voltage outputs of the photovoltaic cells 62 have been compared with the first and second voltage threshold values, the microprocessor 86 generates pointer position data for each photovoltaic cell 62 that outputs a voltage difference greater than the first voltage threshold. The pointer position data is generated by assigning either a hover status or a contact status to position coordinates of each photovoltaic cell 62, based on the known locations of those photovoltaic cells 62 within the OPV layer 50 that were responsible for a voltage output V₀ greater than the first voltage threshold value V₁. The microprocessor 86 then sends the generated position data to the general purpose computing device 28 (step 208) via interface block 88 and the process returns to step 204.

Upon receiving the pointer position data, the general purpose computing device 28 processes the received pointer position data, and the assigned hover or contact status, and updates the image output provided to the display panel 24 of the interactive board 22 for display, if required, so that the image presented on the interactive surface 26 reflects the pointer activity. In this manner, pointer interaction with the interactive surface 26 can be recorded as writing or drawing or used to control execution of one or more application programs running on the general purpose computing device 28.

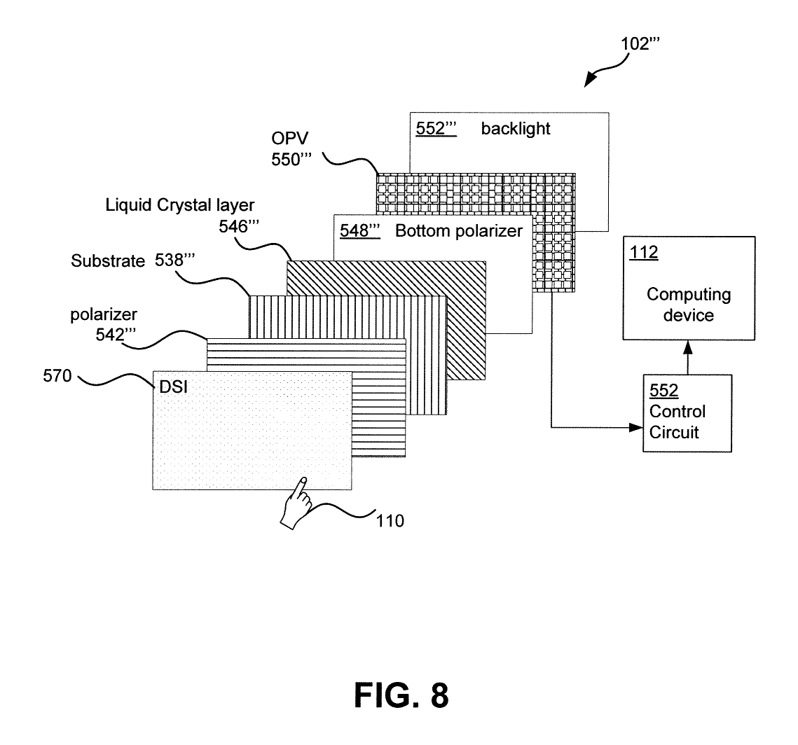

The display panel 24 is not limited to the configuration described above and, in other embodiments, the display panel may have alternative configurations. For example, FIG. 8 shows another embodiment of a display panel, and which is generally referred to using reference numeral 324. Display panel 324 is similar to display panel 24 described above with reference to FIG. 2, and comprises a plurality of transparent and semi-transparent layers that are arranged in a stacked sequence. In this embodiment however, the positions of the second polarizer layer and OPV layer have been reversed. As a result, the display panel 324 comprises, in order from front-to-back or top-to-bottom, a DSI layer 340, a first polarizer layer 342, a substrate layer 344, a liquid crystal layer 346, an OPV layer 350, a second polarizer layer 348 and a backlight layer 352.

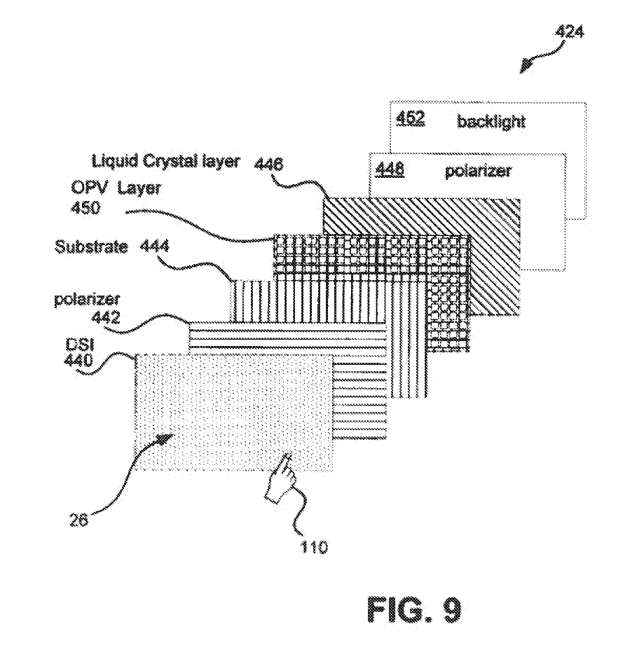

Still other configurations are possible. For example, FIG. 9 shows another embodiment of a display panel, which is generally referred to using reference numeral 424. Display panel 424 is again similar to display panel 24 described above with reference to FIG. 2, and comprises a plurality of transparent and semi-transparent layers that are arranged in a stacked sequence. In this embodiment, the position of the OPV layer has been changed. As a result, the display panel 424 comprises, in order from front-to-back or top-to-bottom, a DSI layer 440, a first polarizer layer 442, a substrate layer 444, an OPV layer 450, a liquid crystal layer 446, a second polarizer layer 448 and a backlight layer 452.

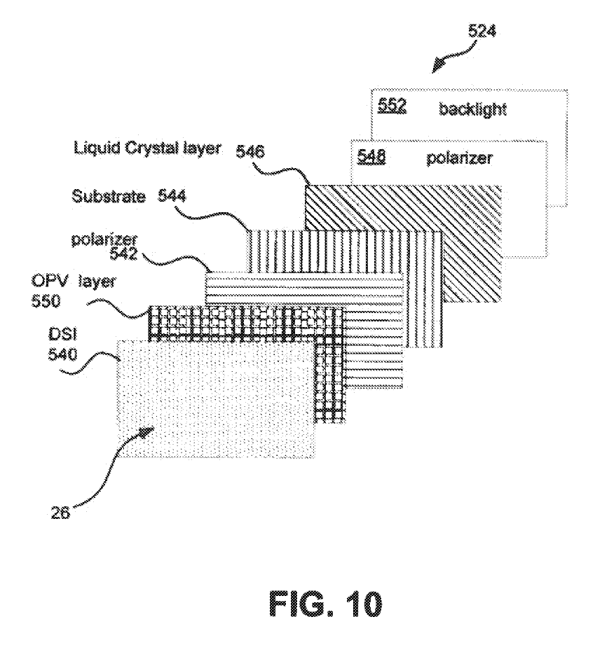

FIG. 10 shows still another embodiment of a display panel, which is generally referred to using reference numeral 524. Display panel 524 once again is similar to display panel 24 described above with reference to FIG. 2, and comprises a plurality of transparent and semi-transparent layers that are arranged in a stacked sequence. In this embodiment, the position of the OPV layer has been changed. As a result, the display panel 524 comprises, in order from front-to-back or top-to-bottom, a DSI layer 540, an OPV layer 550, a first polarizer layer 542, a substrate layer 544, a liquid crystal layer 546, a second polarizer layer 548 and a backlight layer 552.

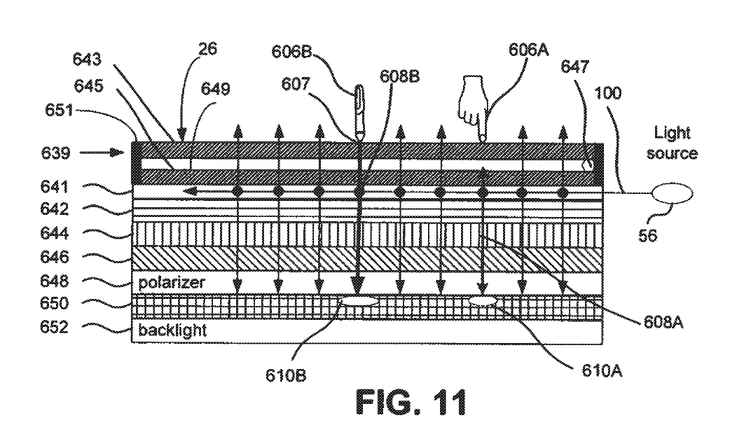

Still other configurations of the display panel are possible. For example, FIG. 11 shows another embodiment of a display panel during use, the display panel being generally referred to using reference numeral 624. In this embodiment, display panel 624 comprises a plurality of transparent and semi-transparent layers that are arranged in a stacked sequence. The display panel 624 comprises, in order from front-to-back or top-to-bottom, a touch panel layer 639, an illumination layer 641, a first polarizer layer 642, a substrate layer 644, a liquid crystal layer 646, a second polarizer layer 648, an OPV layer 650 and a backlight layer 652.

The touch panel layer 639 comprises two transparent panels 643 and 645, with each transparent panel 643 and 645 comprising planar surfaces. In this embodiment, the transparent panels are sheets of glass or other suitable energy transmissive material. Transparent panels 643 and 645 are separated by a spacer 647, such that the transparent panels 643 and 645 are positioned in a spaced and generally parallel relationship, thereby to define a generally uniform gap 649 therebetween. An illumination absorbing material 651 such as, for example, black electrical tape or other suitable material is positioned about the periphery of the touch panel layer 639.

In this embodiment, the light source 56 is positioned adjacent the periphery of the illumination layer 641 and is configured to emit infrared illumination into the plane of the illumination layer 641. The illumination layer 641 in turn scatters illumination 100 such that scattered illumination both travels outwardly into the touch panel layer 639 and inwardly toward the OPV layer 650, such that the OPV layer 650 receives a substantially uniform level of incident illumination over its entire surface area. Illumination entering the touch panel layer 639 travels through the transparent panels 643 and 645.

In the example shown in FIG. 11, a pointer 606A is brought into contact or very close proximity with the interactive surface 26. The pointer 606A redirects scattered illumination travelling within the transparent panel 643 through the gap 649 and into the transparent panel 645. A portion of the redirected scattered illumination exits from an inner surface of the transparent panel 645 and travels toward the OPV layer 650 as ray 608A, and creates a region 610A within the OPV layer 650 having an increased amount of incident illumination. A pen tool 606B comprising an infrared light source is also brought into contact or in very close proximity with the interactive surface 26 of the display panel 626. The light source within the pen tool 606B emits illumination from a tip 607 of the pen tool 606B. The illumination enters the display panel 624 and travels towards the OPV layer 650 as ray 608B, and creates a region 610B within the OPV layer 650 having an increased amount of incident illumination. In this embodiment, the amount of illumination emitted by the pen tool 606B is greater than the amount of illumination of ray 608A redirected by pointer 606A. As a result, region 610B has a greater amount of incident illumination than region 610A. The relative differences in the amount of incident illumination between region 610A, region 610B, and the remainder of the OPV layer 650, are measureable by the OPV layer controller 78 in the manner described above allowing the positions of the pointers 606A and 606B relative to the interactive surface 26 to be determined.

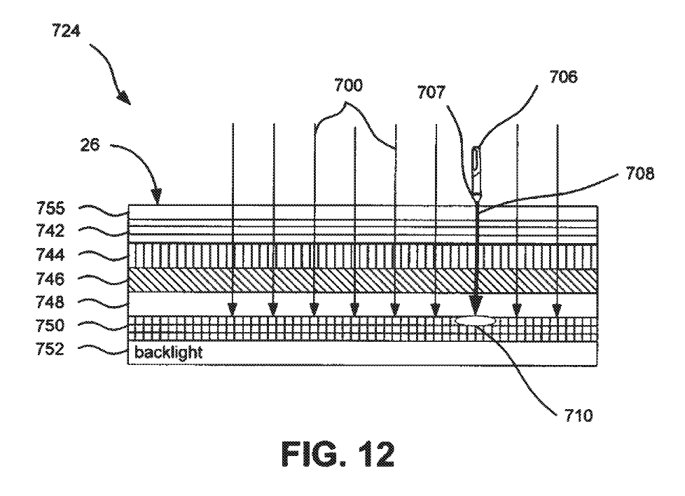

FIG. 12 shows still another embodiment of a display panel during use, the display panel being generally referred to using reference numeral 724. Display panel 724 comprises a plurality of transparent and semi-transparent layers arranged in a generally stacked sequence. The display panel 624 comprises, in order from front-to-back or top-to-bottom, a cover layer 755, a first polarizer layer 742, a substrate layer 744, a liquid crystal layer 746, a second polarizer 748, an OPV layer 750, and a backlight layer 752.

During use, ambient light rays 700 enter the display panel 724 and are incident on the OPV layer 750. In the example shown, a pen tool 706 comprising an infrared light source is brought into contact or very close proximity with the interactive surface 26 of the display panel 724. The light source within the pen tool 706 emits illumination from a tip 707 of the pen tool 706. The illumination enters the display panel 724 and travels towards the OPV layer 750 as ray 708, and creates a region 710 of increased illumination incident on the OPV layer 750. The difference in the amount of illumination incident upon region 710 relative to the remainder OPV layer 750 is measureable by the OPV layer controller 78.

It will be understood that the display panels are not limited to the configurations described above, and may alternatively have other layer configurations.

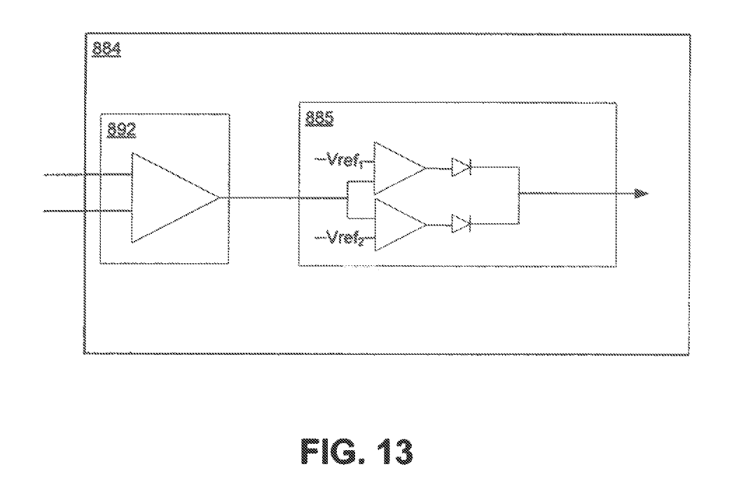

Although in embodiments described above, the analog block comprises an operational amplifier and an analog-to-digital converter, in other embodiments, the analog block may alternatively have other configurations. For example, FIG. 13 shows another embodiment of an analog block for use with the OPV layer controller 78, and which is generally referred to using reference numeral 884. Analog block 884 in this embodiment comprises an operational amplifier (OP-AMP) 892 that is connected to a window comparator 885 configured to provide digital output to the DSP. Window comparators are known in the art, and typically employ two or more operational amplifiers to compare an input signal to a number of reference voltage levels, and output a digital value indicating whether the input signal is between two reference voltage levels. In a related embodiment, a digital block may be used to connect the window comparator to the DSP.

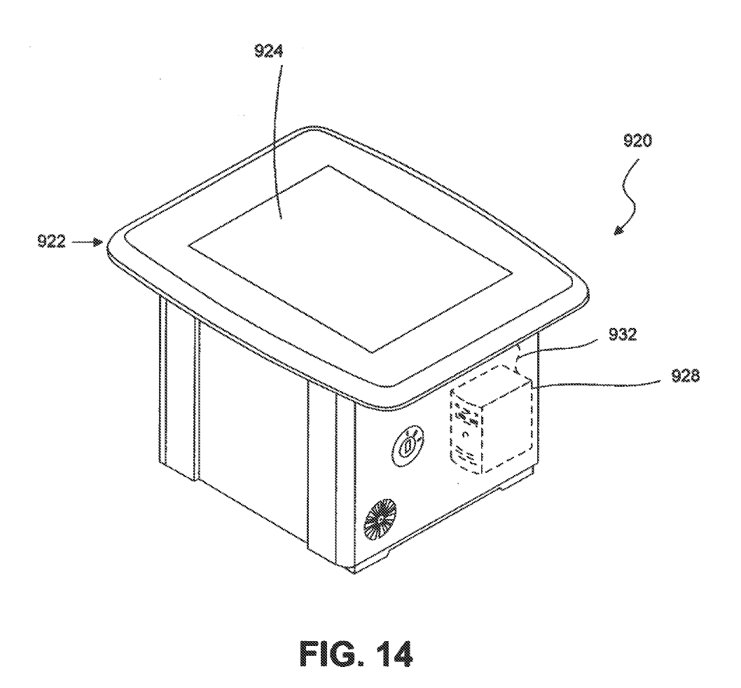

The interactive input system is not limited to the configurations described above and, in other embodiments, the interactive input system may alternatively have other configurations. For example, FIG. 14 shows an embodiment of an interactive input system that is in the form of a touch table, and which is generally referred to using reference numeral 920. Interactive input system 920 comprises a table unit 922 that is configured to rest on a horizontal support surface, such as for example a floor. The table unit 922 comprises a liquid crystal display panel 924 that displays an image, such as for example a computer desktop. The display panel 924 has a generally planar, rectangular display surface that defines an interactive surface 926 and has a structure similar to one of the display panels shown in FIGS. 2 and 8 to 12. The display panel 924 communicates with a general purpose computing device 928 that executes one or more software applications. In this embodiment, the general purpose computing device 928 is housed within the table unit 922.

Although in embodiments described above, the OVP controller comprises a clock source that is embodied within the DSP, in other embodiments, a separate clock generator circuit may alternatively be used.

Although in embodiments described above, the backlight layer comprises an array of light emitting diodes (LEDs) and a diffuser layer adjacent the LEDs for diffusing light emitted therefrom, in other embodiments, the backlight layer may alternatively comprise another light source, such as for example a cold cathode fluorescent lamp (CCFL).

Although in embodiments described above, the display panel comprises a DSI layer, the display panel may alternatively comprise a frustrated total internal reflection (FTIR) layer or other suitable layer configured to scatter illumination.

Although in embodiments described above, the display panel comprises an OPV layer, the photovoltaic layer of the display panel need not be limited to organic materials and in other embodiments, the display panel may alternatively comprise a photovoltaic layer comprising inorganic materials. Also, although in embodiments described above, the OPV layer is flexible, in other embodiments, the OPV layer may alternatively be rigid.

Although in embodiments described above, the photovoltaic cells are configured to absorb light having wavelengths corresponding to the wavelength of the infrared illumination emitted by the light source, in other embodiments, the photovoltaic cells may be configured to absorb light having other wavelengths, such as for example light having wavelengths within the visible or ultraviolet ranges, or light having wavelengths within any combination of the ultraviolet, visible and infrared ranges.

Although in embodiments described above, the light sensitive layer is an OPV layer comprising an array of photovoltaic cells, in other embodiments, the light sensitive layer may comprise other light sensitive elements such as for example an array of photodiodes. As is known in the art, photodiodes may be operated in a reverse-bias mode, in which a bias voltage is applied to the photodiode for generating a photocurrent.

Although the light source 56 is described as being separate from the display panel, those of skill in the art will appreciate that the light source may be integrated with the display panel.

Although embodiments have been described above with reference to the accompanying drawings, those of skill in the art will appreciate that variations and modifications may be made without departing from the scope thereof as defined by the appended claims.

What is claimed is:

1. An interactive input system comprising:
a display panel defining an interactive surface, the display panel comprising a light sensitive layer configured to sense illumination impinging thereon; and
processing structure in communication with the display panel, said processing structure processing output of the light sensitive layer to detect at least one pointer in proximity with the interactive surface.

2. The interactive input system of claim 1, wherein the display panel further comprises a layer configured to scatter illumination emitted by a light source.

3. The interactive input system of claim 2, wherein said layer scatters illumination such that said scattered illumination both (i) impinges on said light sensitive layer and (ii) exits said display panel for reflection back into said display panel and onto said light sensitive layer by at least one pointer in proximity with said interactive surface.

4. The interactive input system of claim 3, wherein the scattered illumination impinging on said light sensitive layer is of a generally uniform intensity over the surface area thereof.

5. The interactive input system of claim 4, wherein said illumination is infrared illumination.

6. The interactive input system of claim 5, wherein said light sensitive layer comprises an array of light sensitive elements, each light sensitive element generating a measurable output that is a function of illumination impinging thereon.

7. The interactive input system of claim 6, wherein said light sensitive elements comprise an array of photovoltaic cells or an array of photodiodes.

8. The interactive input system of claim 7, wherein the photovoltaic cells are organic photovoltaic cells.

9. The interactive input system of claim 7, wherein the light sensitive layer is flexible.

10. The interactive input system of claim 3, wherein said display panel is a liquid crystal display panel.

11. The interactive input system of claim 10 wherein the scattering layer is adjacent the interactive surface.

12. A method comprising:
detecting illumination reflected into a display panel by a pointer brought into proximity with the display panel; and
detecting the existence and status of the pointer based on the detected illumination.

13. The method of claim 12, wherein the detecting is performed by an array of light sensitive elements within said display panel and wherein during the second detecting, outputs of the light sensitive elements are compared to a first threshold value and a second threshold value to determine hover or contact status of said pointer.

14. A display panel comprising:
a light sensitive layer; and
a layer configured to scatter received illumination in one direction so that the scattered illumination impinges generally evenly on said light sensitive layer and in an opposite direction so that said scattered illumination exits said display panel, scattered illumination exiting said display panel that is reflected by a pointer in proximity thereto and travels back into said display panel, impinging on said light sensitive layer.

15. The display panel of claim 14, wherein said light sensitive layer comprises an array of light sensitive elements, each light sensitive element generating a measurable output that is a function of illumination impinging thereon.

16. The display panel of claim 15, wherein said light sensitive elements comprise an array of photovoltaic cells or an array of photodiodes.

17. The display panel of claim 16, wherein the photovoltaic cells are organic photovoltaic cells.

18. The display panel of claim 15, wherein the light sensitive layer is flexible.

19. The display panel of claim 14, wherein said display panel is a liquid crystal display panel.

20. The display panel of claim 19 wherein the scattering layer is adjacent an interactive surface thereof

21. The display panel of claim 14, further comprising a light source configured to direct illumination onto said layer.
